(19) United States
(12) Patent Application Publication
(10) Pub. No.: US 2024/0020087 A1
(43) Pub. Date: Jan. 18, 2024

(54) VEHICLE APPARATUS FOR DISPLAYING AND RECEIVING CONTENT IMAGE INFORMATION FROM AN EXTERNAL DEVICE AND A METHOD THEREOF

(71) Applicants: HYUNDAI MOTOR COMPANY, Seoul (KR); KIA CORPORATION, Seoul (KR)

(72) Inventor: Seong Soo Yae, Hwaseong-si (KR)

(73) Assignees: HYUNDAI MOTOR COMPANY, Seoul (KR); KIA CORPORATION, Seoul (KR)

(21) Appl. No.: 18/077,852

(22) Filed: Dec. 8, 2022

(30) Foreign Application Priority Data
Jul. 14, 2022 (KR) 10-2022-0087036

(51) Int. Cl. G06F 3/16; G06F 3/14; H04L 67/60

(52) U.S. Cl. CPC G06F 3/165; G06F 3/14; H04L 67/60

(57) ABSTRACT

Disclosed is a vehicle apparatus for displaying content image information received from an external device. The vehicle apparatus includes: a communication device configured to be communication-connected with an external device; a processor configured to check a content driving app of the external device, when content playback is started by the content driving app of the external device, to check a content image information request time for each driving app, when the content image information request time for each driving app arrives, to request content image information from the external device, and to change the content image information request time for each driving app by verifying a change in a time it takes to receive the content image information for each driving app; a storage configured to store data and algorithms driven by the processor; and a display device configured to display the content image information.

### CROSS-REFERENCE TO RELATED APPLICATION

This application claims priority to and the benefit of Korean Patent Application No. 10-2022-0087036, filed in the Korean Intellectual Property Office on Jul. 14, 2022, the entire contents of which are incorporated herein by reference.

### BACKGROUND

### (a) Field

The present disclosure relates to a vehicle apparatus and a method for displaying content image information received from an external device, and more particularly, to a content display technique through wireless communication between the vehicle apparatus and a mobile terminal.

### (b) Description of the Related Art

Recently, an increasing number of users are streaming a content such as music from an external device (e.g., a mobile terminal) in a vehicle.

Accordingly, when a vehicle apparatus directly receives an album art of a sound stored in the external device or no album art exists in the external device, the album art is downloaded from the external server (e.g., cloud) and the album art of the sound source being played is displayed on a screen of the vehicle apparatus.

However, such a method is currently supported only in an operating system (OS) and an application (app) where a function of transferring album art itself is limited, and thus compatibility is not yet mature. In other words, all mobile terminals and all music apps do not support this function.

In addition, even when there is no problem with support in the OS, development depends on unique specifications of the app, and thus there are many cases in which album art is not displayed properly due to many problems in the transmission and reception of the album art between the vehicle apparatus and the external device.

The above information disclosed in this Background section is only to enhance understanding of the background of the present disclosure, and thus it may contain information that does not form the prior art that is already known to a person of ordinary skill in the art.

### SUMMARY

The present disclosure provides a vehicle apparatus and a method for displaying content image information received from an external device, which are capable of displaying the content image information on the vehicle apparatus regardless of specifications of an operating system (OS) of the external device and a content execution application (app) when streaming content from the external device.

The technical objects of the present disclosure are not limited to the objects mentioned above, and other technical objects not mentioned may be clearly understood by those having ordinary skill in the art from the description of the claims.

An embodiment of the present disclosure provides a vehicle apparatus including a communication device configured to be communication-connected with an external device. The vehicle apparatus also includes a processor configured to check a content driving app of the external device, when content playback is started by the content driving app of the external device. The processor is also configured to check a content image information request time for each driving app, when the content image information request time for each driving app arrives. The processor is also configured to request content image information from the external device. The processor is also configured to change the content image information request time for each driving app by verifying a change in a time it takes to receive the content image information for each driving app. The vehicle apparatus also includes a storage configured to store data and algorithms driven by the processor. The vehicle apparatus also includes a display device configured to display the content image information.

In an embodiment of the present disclosure, the content image information may include data in which a time for receiving the content image information for each driving app is changed depending on specifications of the content driving app of the external device and an OS of the external device.

In an embodiment of the present disclosure, the content image information may include at least one of album art, a broadcast representative image, an advertisement image, or any combination thereof.

In an embodiment of the present disclosure, the storage may be further configured to store an album art request time for each content driving app of the external device. The processor may be further configured to check the album art request time for each content driving app of the external device stored in the storage. The processor may be further configured to update a content image information request time for each driving app to the storage when changing the content image information request time.

In an embodiment of the present disclosure, the processor when the content driving app of the external device is activated to play a content back, may be configured to check a content image information request time of the content driving app of the external device and may be configured to make a first request to the external device for content item information related to the content being played.

In an embodiment of the present disclosure, the content image information may include at least one of album art, a broadcast representative image, an advertisement image, or any combination thereof.

In an embodiment of the present disclosure, the processor may be further configured to determine whether a content image information ID exists in the content item information when the content item information is received from the external device. The processor may be further configured to request content image information corresponding to the content image information ID from the external device when the content image information ID exists.

In an embodiment of the present disclosure, the processor may be further configured to request the content image information from the external device after a time corresponding to the content image information request time of the content driving app of the external device has elapsed from a time of the first request for the content item information.

In an embodiment of the present disclosure, the processor may be further configured to make a second request for the content item information when the content image information ID does not exist in the content item information.

In an embodiment of the present disclosure, the processor may be further configured to request the content image information from an external server when the content image information ID does not exist in the content item information received through the second request.

In an embodiment of the present disclosure, the processor may be further configured to request the content image information from an external server when the content image information ID exists in the content item information and content image information is requested from the external device based on the content image information ID, but a content image is not received from the external device.

In an embodiment of the present disclosure, the processor may be further configured to request the content image information from the external server. When the content image information is not received within a predetermined time, the processor may be further configured to display default content image information on the display device.

In an embodiment of the present disclosure, when the content driving app being executed is changed or a content being played is changed, the processor may be further configured to check a content image information request time of the changed content driving app and request the content image information from the external device based on a content image information request time of the changed content driving app. When the content image information is not received from the external device, the processor may be further configured to increase the content image information request time of the changed content driving app by a predetermined unit time.

In an embodiment of the present disclosure, the processor may be configured to re-request the content image information from the external device based on the increased content image information request time. The processor, when the content image information is received from the external device, may be further configured to update the increased content image information request time to the storage.

In an embodiment of the present disclosure, the processor may be further configured to update the increased content image information request time to the storage when each content image information is received for a predetermined number of contents based on the increased content image information request time.

In an embodiment of the present disclosure, the processor when a content being played are changed, may be further configured to check a content image information request time of the changed content and determine whether a predetermined change period has arrived. The processor, when the predetermined change period has arrived, may be further configured to decrease the content image information request time of the changed content by a predetermined unit time.

In an embodiment of the present disclosure, the processor may be further configured to request content image information of the changed content from the external device based on the decreased content image information request time. The processor, when the content image information is received from the external device, may be further configured to update the decreased content image information request time to the storage when each content image information is received for a predetermined number of contents based on the decreased content image information request time.

In an embodiment of the present disclosure, the processor, although connected to the external device, when other media is operated, may be further configured to verify whether it is necessary to increase or decrease the content image information request time of the content driving app of the external device in a background.

In an embodiment of the present disclosure, the processor, when the driving app of the external device is executed while verifying whether it is necessary to increase or decrease the content image information request time, may be further configured to return a track moved for verifying whether it is necessary to increase or decrease the content image information request time, to a track before verification to play the track.

An embodiment of the present disclosure provides a method of displaying content image information received from an external device, including performing, by a processor, communication connection for providing content with an external device. The method also includes checking, by the processor, a content driving app of the external device. The method also includes checking, by the processor, a content image information request time for each driving app when content playback is started by the content driving app of the external device. The method also includes requesting, by the processor, the content image information from the external device when the content image information request time for each driving app arrives. The method also includes changing the content image information request time for each driving app by verifying a change in a time it takes to receive the content image information for each driving app. The method also includes displaying the content image information that is received based on the changed content image information request time.

According to the present disclosure, it is possible to display content image information on a vehicle apparatus regardless of specifications of an OS of an external device and a content execution app when streaming content from the external device.

Furthermore, various effects that can be directly or indirectly identified through this document may be provided.

### BRIEF DESCRIPTION OF THE DRAWINGS

In order that the disclosure may be well understood, there will now be described various forms thereof, given by way of example, reference being made to the accompanying drawings, in which:

FIG. 1 illustrates a block diagram showing a configuration of a system for streaming content and providing content image information from an external device in a vehicle according to an embodiment of the present disclosure;

FIG. 2 illustrates a view for describing a process of requesting and displaying album art in a vehicle apparatus according to an embodiment of the present disclosure;

FIG. 3 illustrates a flowchart illustrating a method of displaying content image information on a vehicle apparatus regardless of specifications of an OS of an external device and a content execution app according to an embodiment of the present disclosure;

FIG. 4A illustrates a flowchart for describing a method of increasing and changing an album art request delay value according to an embodiment of the present disclosure;

FIG. 4B illustrates an example table of changing an album art request delay value according to an embodiment of the present disclosure;

FIG. 5A illustrates a flowchart for describing a method of decreasing and changing an album art request delay value according to an embodiment of the present disclosure;

FIG. 5B illustrates an example of a table of a change and a change period for an album art request delay value according to an embodiment of the present disclosure;

FIG. 6A and FIG. 6B each illustrate a flowchart for describing a method of decreasing or changing an album art request delay value while playing external linked media according to an embodiment of the present disclosure; and

FIG. 7 illustrates a computing system according to an embodiment of the present disclosure.

The drawings described herein are for illustration purposes only and are not intended to limit the scope of the present disclosure in any way.

### DETAILED DESCRIPTION

Hereinafter, some embodiments of the present disclosure are described in detail with reference to drawings. It should be noted that in adding reference numerals to constituent elements of each drawing, the same or equivalent constituent elements have the same reference numerals as possible even though they are indicated on different drawings. Furthermore, in describing embodiments of the present disclosure, when it is determined that detailed descriptions of related well-known configurations or functions interfere with understanding of the embodiments of the present disclosure, the detailed descriptions thereof have been omitted.

In describing constituent elements according to an embodiment of the present disclosure, terms such as first, second, A, B, (a), and (b) may be used. These terms are only for distinguishing the constituent elements from other constituent elements, and the nature, sequences, or orders of the constituent elements are not limited by the terms. Furthermore, all terms used herein including technical scientific terms have the same meanings as those generally understood by those having ordinary skill in the technical field to which an embodiment of the present disclosure pertains (those having ordinary skill in the art) unless they are differently defined. Terms defined in a generally used dictionary shall be construed to have meanings matching those in the context of a related art and shall not be construed to have idealized or excessively formal meanings unless they are clearly defined in the present specification. When a component, device, element, or the like of the present disclosure is described as having a purpose or performing an operation, function, or the like, the component, device, or element should be considered herein as being “configured to” meet that purpose or to perform that operation or function.

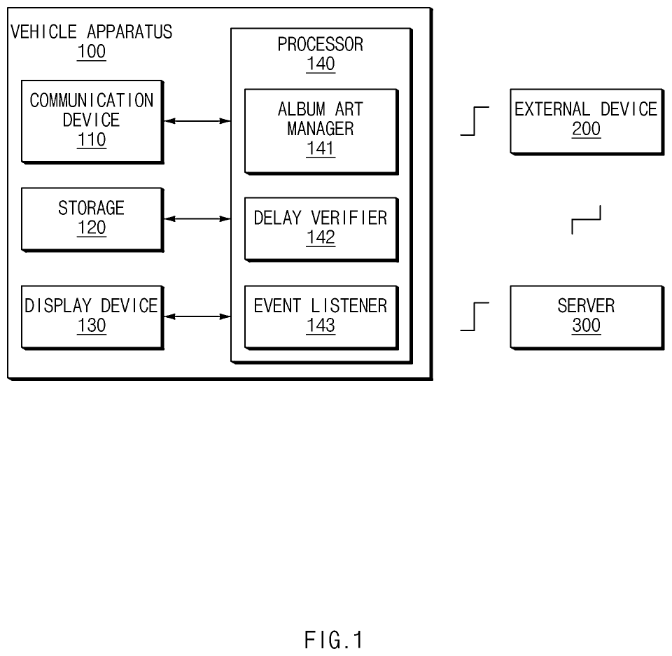

Hereinafter, various embodiments of the present disclosure have been described in detail with reference to FIG. 1-FIG. 7.

The present disclosure discloses a technique for displaying album art (cover art, a broadcast representative image, an advertisement image, etc.) when content is streamed in connection with an external device such as a mobile terminal in a vehicle. Hereinafter, album art is described as an example, but the present disclosure is not limited thereto. It may be applied to all content image information affected by specifications of an operating system (OS) and an application (app) of the external device.

FIG. 1 illustrates a block diagram showing a configuration of a system for streaming content and providing content image information from an external device in a vehicle according to an embodiment of the present disclosure.

Referring to FIG. 1, a vehicle apparatus 100 performs wireless communication with an external device 200 and a server 300.

The vehicle apparatus 100 according to an embodiment of the present disclosure may be implemented inside the vehicle. In this case, the vehicle apparatus 100 may be integrally formed with internal control units of the vehicle or may be implemented as a separate device to be connected to control units of the vehicle by a separate connection means.

The vehicle apparatus 100 may check a content driving app (e.g., a type of a music app) of the external device 200. When playpack of content (e.g., sound source) is started by the content driving app of the external device 200, the vehicle apparatus 100 may also determine whether a time for requesting content image information (e.g., the album art request delay value) for each driving app has arrived by checking the time for requesting the content image information for each driving app. Accordingly, the vehicle device 100 may request the content image information (e.g., album art) to the external device 200 when the request time for the content image information for each driving app arrives and may change the request time for content image information for each driven app by verifying a change in a time it takes to receive the content image information for each driving app. In this case, the content image information includes data in which the time for receiving the content image information for each driving app is changed depending on the specifications of the content driving app of the external device 200 and the OS of the external device 200. In other words, the content image information may include at least one of album art, a broadcast representative image, an advertisement image, or any combination thereof.

Accordingly, the vehicle apparatus 100 requests the content image information using the changed request time for the content image information and, when the content image information is received, displays it on a screen during content playback.

The external device 200 may perform wireless communication with the vehicle apparatus 100 and may include all mobile communication terminals such as smartphones, tablet PCs, pads, personal digital assistants (PDA), wearable devices, laptops, etc. An operating system (OS) may be installed on the external device 200, and apps for driving contents may be installed on the OS. In this case, a time for providing the content image information may be different for apps for driving content, and the time for providing the content image information may be changed (decreased or increased) depending on an update of the apps, etc.

The server 300, which is a server that provides a music app, content, and the like, may provide content image information when receiving a content image information request from the external device 200 or the vehicle apparatus 100.

The vehicle apparatus 100 may include a communication device 110, a storage 120, a display 120, and a processor 140.

The communication device 110 is a hardware device implemented with various electronic circuits to transmit and receive signals through a wireless or wired connection and may transmit and receive information based on in-vehicle devices and in-vehicle network communication techniques. As an example, the in-vehicle network communication techniques may include controller area network (CAN) communication, local interconnect network (LIN) communication, flex-ray communication, and the like.

In addition, the communication device 110 may perform communication by using a server, infrastructure, or third vehicles outside the vehicle, and the like through a wireless Internet access or short range communication technique. Herein, the wireless communication technique may include wireless LAN (WLAN), wireless broadband (Wibro), Wi-Fi, world Interoperability for microwave access (Wimax), etc. In addition, short-range communication technique may include bluetooth, ZigBee, ultra wideband (UWB), radio frequency identification (RFID), infrared data association (IrDA), and the like.

As an example, the communication device 110 may perform wireless communication with the external device 200 and the server 300 and may transmit and receive content, content item information (an album title, a song name, a composer name, an album art ID, etc.), and content image information (e.g., album art).

The storage 120 may store data and/or algorithms required for the processor 140 to operate, and the like.

As an example, the storage 120 may store a music app timer management table. The music app timer management table may include an album art request delay value (Rd), a change period (Tp), and the like for each music app. In addition, the storage 120 may include a music app timer management database.

The storage 120 may include a storage medium of at least one type among memories of types such as a flash memory, a hard disk, a micro, a card (e.g., a secure digital (SD) card or an extreme digital (XD) card), a random access memory (RAM), a static RAM (SRAM), a read-only memory (ROM), a programmable ROM (PROM), an electrically erasable PROM (EEPROM), a magnetic memory (MRAM), a magnetic disk, and an optical disk.

The display device 130 may include an input means for receiving a control command from a user and an output means for outputting an operation state of the apparatus 100 and results thereof. Herein, the input means may include a key button, and may include a mouse, a joystick, a jog shuttle, a stylus pen, and the like. Furthermore, the input means may include a soft key implemented on the display.

The interface device 130 may be implemented as a head-up display (HUD), a cluster, an audio video navigation (AVN), a human machine interface (HM), a user select menu (USM).

The output device may include a display and may also include a voice output means such as a speaker. In the instant case, when a touch sensor formed of a touch film, a touch sheet, or a touch pad is provided on the display, the display may operate as a touch screen and may be implemented in a form in which an input device and an output device are integrated.

For example, the output device may output information (e.g., a song name, an album name, a singer, etc.) of a sound source being reproduced, album art, and the like.

In the instant case, the display may include at least one of a liquid crystal display (LCD), a thin film transistor liquid crystal display (TFT LCD), an organic light emitting diode display (OLED display), a flexible display, a field emission display (FED), a 3D display, or any combination thereof.

The processor 140 may be electrically connected to the communication device 110, the storage 120, the display device 130, and the like, may electrically control each component, and may be an electrical circuit that executes software commands. Thus, various data processing and calculations may be performed as described below.

The processor 140 may process a signal transferred between each component of the vehicle apparatus 100 and perform general control such that each of the components can perform their functions normally. In addition, the processor 140 may be implemented in the form of hardware, software, or a combination of hardware and software. For example, it may be, e.g., an electronic control unit (ECU), a micro controller unit (MCU), or other sub-controllers mounted in the vehicle.

When a content driving app of the external device 200 is activated to play content back, the processor 140 may check a content image information request time (e.g., an album art request delay value) of the content driving app of the external device 200 and may make a first request to the external device 200 for content item information on the content being played back. In this case, the content item information may include at least one of an album name, a song name, a composer name, an album art ID, or any combination thereof.

The processor 140 may determine whether a content image information ID exists in content item information when the content item information is received from the external device 200 and may request content image information corresponding to the content image information ID from the external device 200 when the content image information ID exists.

The processor 140 may request content image information from the external device 200 after a time corresponding to the content image information request time of the content driving app of the external device 200 has elapsed from a time of the first request for content item information.

When the content image information ID does not exist in the content item information, the processor 140 may make a second request for song information.

The processor 140 may request the content image information from an external server when the content image information ID does not exist in the song information received through the second request. The processor 140 may request content image information from the external server when the content image information ID exists in the content item information and the content image information is requested to the external device 200 based on the content image information ID. However, the content image is not received from the external device 200.

The processor 140 may display default content image information on the display device 130 when the content image information is not received within a predetermined time (e.g., 3000 ms) after requesting the content image information from the external server 300.

The processor 140 may check a content image information request time of a changed content driving app when the content driving app being executed is changed or the content being played is changed, may request the content image information from the external device 200 based on a content image information request time of the changed content driving app, and may increase the content image information request time of the changed content driving app by a predetermined unit time when the content image information is not received from the external device 200.

The processor 140 may re-request the content image information from the external device 200 based on the increased content image information request time and, when the content image information is received from the external device 200, may update the increased content image information request time to the storage 120.

The processor 140 may update the increased content image information request time to the storage 120 when each content image information is received for a predetermined number of contents based on the increased content image information request time,

The processor 140 checks a content image information request time of the changed content when the content being played has changed and may reduce the content image information request time of the changed content by a predetermined unit time when a predetermined change period has arrived by determining whether the predetermined change period has arrived.

The processor 140 may request the content image information of the content changed based on the reduced content image information request time from the external device 200. When the content image information is received from the external device 200 and when the content image information is received for a predetermined number of content based on the reduced content image information request time, the processor 140 may update the reduced content image information request time to the storage 120.

Although being connected to the external device 200, when other media is played back, the processor 140 may verify whether the content image information request time of the content driving app of the external device 200 needs to be increased or decreased as a background.

The processor 140 may include an album art manager 141, a delay verifier 142, and an event listener 143.

The album art manager 141 include a logic for handling a case in which a response comes to report that album art (album art ID) exists and a case in which a response comes to report that no album art exists from the external device 200 when requesting song information from the external device 200 through the communication device 110.

When the response comes from the external device 200 to report that album art exists, the album art manager 141 receives a value of “AlbumArtID”. When this value is received, the album art manager 141 uses this value to request album art again from the external device 200 again by using getImage(AlbumArtID).

When the response comes from the external device 200 to report that no album art exists, the album art manager 141 requests album art from the server 300 that provides external album art based on the song information currently being played in the vehicle because album art cannot be received from the external device 200.

The album art manager 141 sets an album art request delay value Rd, which is a time when the album art is requested, after checking it from a music app timer management table.

The album art manager 141 displays the album art on the display device 130 when the album art is normally received. When an album art image is not ready in a music app (when the UID value is null), the album art manager 141 waits for a while for a time for album art to be prepared in the app of the external device 200 and then makes a request again.

Although having received an UID of the album art from the external device 200, even when there is no corresponding image, the album art manager 141 waits for a while and then makes the request again.

During an album art request period, album art of a changed song is not displayed and album art of a previous track is maintained. In addition, when there is no response from the external device 200 to a re-request, it is determined that there is no album art in the external device 200 and the vehicle requests the album art from the server 300. However, when there is no album art even in the server 300, default album art possessed by the vehicle is displayed at this time.

The delay verifier 142 is in charge of an adaptive transmission function of album art. In other words, when the vehicle and the external device 200 are connected, the delay verifier 142 checks the music app of the external device 200 and monitors the album art response time, tests an interlocking characteristic of the music app of the external device 200 connected thereto by itself in order to determine when a change is necessary, and updates a test result thereof in a music app timer management database.

The delay verifier 142 may respond to a case where album art is not ready in the music app of the external device 200 or a case where the music app of the external device 200 reports that album art image is ready, but there is no actual image, and this is described in detail below.

There are two types of changes that may occur in transferring of the album art in the music app of the external device 200.

First, the album art may be prepared faster than before to be transferred to the vehicle. In this case, it is necessary to reduce an album art request time (an album art request delay value) such that the album art can be retrieved faster in order to display changed song information faster than before.

Second, the album art is prepared more slowly than before and thus the normal album art is not displayed depending on an existing logic. In this case, since the album art cannot be received normally when requested by the vehicle as quickly as before, a request time needs to be increased so as to request the album art more slowly than a time for the vehicle to request album art from the external device 200 (a default album art request delay value).

Accordingly, when the music app of the external device 200 is selected, the delay verifier 142 starts an operation for requesting album art. The external device 200 may transmit changed information to the vehicle device 100 whenever the music app is changed.

When album art is received well, but suddenly the album art is not received, the delay verifier 142 determines that an album art preparation time of the corresponding music app has increased, and the delay verifier 142 performs a test while gradually increasing a current album art request delay value. For example, each time a song is changed, the test is performed by increasing a unit value (e.g., 100 ms) from the existing album art request delay value, and when the album art is still not received, the test is performed by further increasing the album art request delay value by the unit value.

In addition, the delay verifier 142 may make a request by increasing the album art request delay value up to a predetermined maximum value (Max) without increasing it indefinitely. For example, Max may be defined as 3000 ms.

The delay verifier 142 checks whether an album art ID is transferred while increasing a time for requesting album art every time a song is changed, and the delay verifier 142 checks whether the album art is received by requesting the album art based on the album art ID. In this case, it may be determined that the changed album art request delay value is effective only when the album art is received.

When the album art ID is received but an image album art file is not received from the actual external device 200, the delay verifier 142 determines that it is a failure, and the delay verifier 142 increases the album art request delay value again. When the album art is successfully received, the delay verifier 142 determines whether all album art is received every 5 track changes within the corresponding album art request delay value and, when all are received, updates the corresponding album art request delay value to the music app timer management database.

The delay verifier 142 has no significant effect on a user even when a previous album art request delay value is maintained when the album art is suddenly quickly received. However, the album art is received first and displayed after waiting, and thus since the album art is being displayed too slowly, it is necessary to improve it such that the album art can be displayed more quickly.

In this case, there is no way to know whether an album art preparation time of the music app has improved because the album art is not suddenly provided. Accordingly, the delay verifier 142 needs to periodically determine whether the album art request delay value is shortened. In other words, the delay verifier 142 checks whether there is a problem even when a unit time (e.g., 100 ms) is reduced every predetermined change period Tp. In this case, the unit time may be predetermined by an experimental value.

When album art is requested and received successfully in a state in which the album art request delay value reduced, the delay verifier 142 requests and receives an album based on the reduced album art request delay value for 5 track changes. When it succeeds all 5 times, the delay verifier 142 updates the corresponding album art request delay value to the music app timer management database.

However, the delay verifier 142 reduces the album art request delay value once more when album art is requested and fails to be received in a state in which the album art request delay value reduced. In this case, the delay verifier 142 may not reduce the album art request delay value to 0 but may reduce the album art request delay value to the minimum value (Min) to test the album art request delay value. A minimum value may be 200 ms and may be predetermined by an experimental value.

In addition, the delay verifier 142 may set the change period Tp to 30 days in consideration of an update period of the music app of the external device 200. The delay verifier 142 may add the change period Tp by +1 every day and, when the change period reaches 30, may verify the album art request delay value of the music app that is linked with the vehicle.

The delay verifier 142 may automatically check the album art request delay value in a different-media mode. In other words, the delay verifier 142 may verify the album art request delay value of the music app while a user listens to a FM radio or the like of the external device 200. In other words, the delay verifier 142 may verify the album art request delay value of the music app even when the user does not activate a Bluetooth audio linked with the music app.

When the external device 200 is connected to the vehicle, the delay verifier 142 is in a controllable state even when the vehicle does not select a corresponding mode and play it back. Accordingly, the delay verifier 142 may check the music app that is executed on the connected external device 200, may track up in a background, and may check whether the album art normally comes in the background. The delay verifier 142 may verify the album art request delay value in the background without a user noticing it.

However, a customer can turn on a linkage mode of the external device 200 during an album art test, the delay verifier 142 stores a number of track-ups performed in a song at the time of starting a background test and then needs to be restored when the external device 200 enters the linkage mode. For example, the delay verifier 142 may restore a track to the previous track-up to 3 times to allow it to be played from that point when the user wants to play the sound source by activating a Melon app of the external device 200 during verification of the album art request delay value of the music app after 3 track-ups in the background while the user is listening to a FM radio.

In other words, while verifying the album art request delay value in the background, a time of track restoration is \textcircled{1} when the test is completed and \textcircled{2} when the linkage mode of the external device is entered during the test.

The delay verifier 142 checks the album art request delay value once only for the music app selected when the external device is connected, unlike verification during sound source playback.

The event listener 143 monitors an event occurring in the external device 200. In other words, the event listener 143 may monitor whether a track or a music app is changed in the external device 200 and may call an album art request delay value Rt for each music app when an event occurs or may perform a necessary operation (getting and displaying song information) when changing a track.

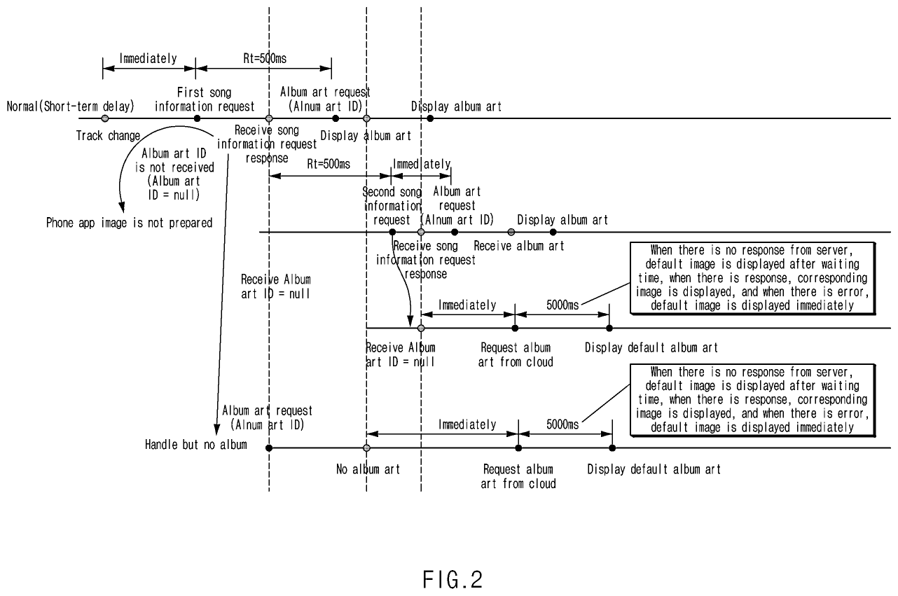

FIG. 2 illustrates a view for describing a process of requesting and displaying album art in a vehicle apparatus according to an embodiment of the present disclosure.

Referring to FIG. 2, the vehicle apparatus 100 immediately requests the first song information from the external device 200 when a media track is changed. Thereafter, the vehicle apparatus 100 determines whether an album art ID exists when the song information is received, the vehicle apparatus 100 requests album art from the external device 200 after an album art request delay value of 500 ms after requesting the first song information when the album art ID exists, and the vehicle apparatus 100 displays the album art when it is received.

The vehicle apparatus 100 makes a second request for song information 500 ms after a song information response time when there is no album art ID in a response after the first request for song information. Thereafter, the vehicle apparatus 100 determines whether an album art ID exists after a song information response to the second song information request, immediately requests album art when the ID exists, and displays the album art when it is received.

On the other hand, when the album art ID does not exist after the song information response to the second song information request, the vehicle apparatus 100 immediately requests the album art from the server (cloud) 300. The vehicle apparatus 100 displays album art when it is received from the server 300 within 5000 ms and displays a default image when the album art is not received from the server 300 within 5000 ms.

In addition, when there is the album art ID in the response after the first request for song information, but there is no actual album art, the vehicle device 100 immediately requests the album art from the server (cloud) 300. The vehicle apparatus 100 displays album art when it is received from the server 300 within 5000 ms and displays a default image when the album art is not received from the server 300 within 5000 ms.

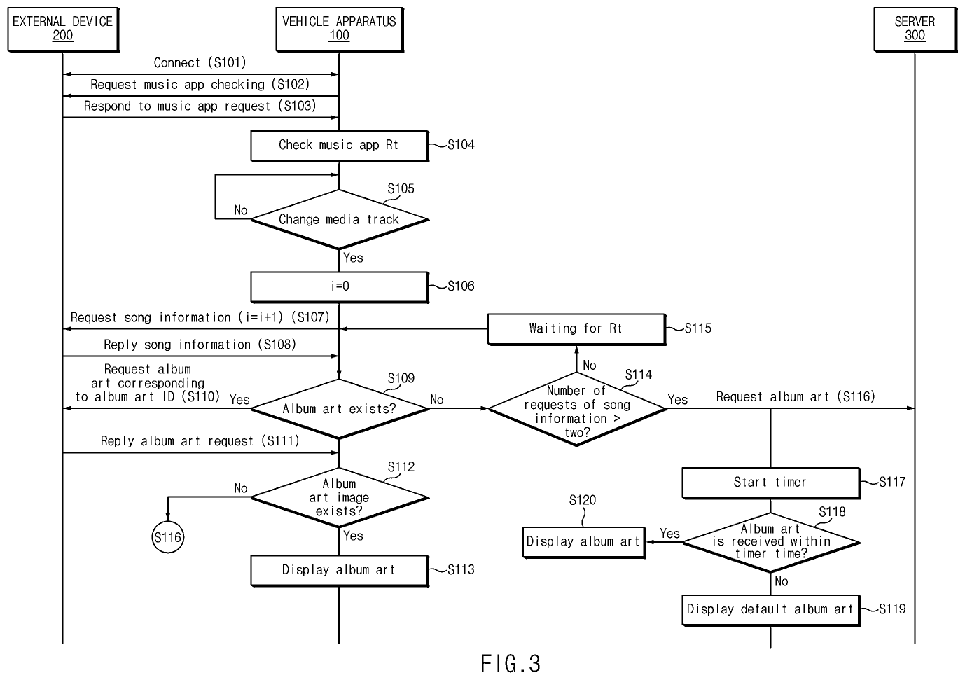

Hereinafter, a method of displaying content image information on a vehicle apparatus regardless of specifications of an OS of an external device and a content execution app according to an embodiment of the present disclosure is described in detail with reference to FIG. 3. FIG. 3 illustrates a flowchart illustrating a method of displaying content image information on a vehicle apparatus regardless of specifications of an OS of an external device and a content execution app according to an embodiment of the present disclosure.

Hereinafter, it is assumed that the vehicle apparatus 100 of FIG. 1 performs a process of FIG. 3. In addition, in the description of FIG. 3, operations described as being performed by a device may be understood as being controlled by the processor 140 of the vehicle apparatus 100. Hereinafter, in FIG. 3, an example of displaying album art when streaming a sound source among contents is described.

Referring to FIG. 3, when the vehicle apparatus 100 is wirelessly connected to the external device 200 for sound streaming (S101), the vehicle apparatus 100 requests confirmation of the music app from the external device 200 (S102). In other words, a type of a music app used for sound streaming may be checked by the external device 200. For example, the type of the music app may include Melon, YouTube Music, Spotify, Genie Music, Amazon Music, Tidal, and the like.

Then, the vehicle apparatus 100 may receive a response to the confirmation of the music app from the external device 200 (S103) and may check the album art request delay value of the corresponding music app (S104). In this case, the album art request delay value for each music app may be stored in advance in the storage 120. In addition, the album art request delay value for each music app may be initially stored as a default value, and the album art request delay value may change depending on the update of the music app later, and thus a change in the album art request delay value may be identified to modify and store the album art request delay value.

The vehicle apparatus 100 determines whether a media track is changed during sound source playback (S105). Changing the media track indicates changing the song.

When the media track is changed (Yes in S105), the vehicle apparatus 100 sets i=0 (S106), requests song information from the external device 200, and adds 1 to i (S107). In this case, i indicates a number of requests for song information. In addition, the song information may include an album name, a singer name, a song name, an album ID, and the like.

Accordingly, the vehicle device 100 receives the song information from the external device 200 (S108) and determines whether the album art ID exists in the song information (S109).

When the album art ID exists (Yes in S109), the vehicle apparatus 100 requests the album art for the corresponding album art ID from the external device 200 (S110). In this case, the album art indicates a picture or a photo printed on a front cover of an album.

When receiving a response to the album art request from the external device 200 (S111), the vehicle apparatus 100 determines whether an album art image actually exists (S112).

Accordingly, when the album art image exists (Yes in S112), the vehicle apparatus 100 displays the album art on the display device 130 (S113). On the other hand, when the album art image does not exist (No in S112), the album art may be requested from the external server 300, and this process is described below in S116 below.

When there is no album art ID in step S109 (No in S109), the vehicle apparatus 100 determines whether the number of requests for song information is two or more (S114). When the number of requests for song information is less than two (No in S114), the vehicle apparatus 100 waits for the album art request delay value and then requests the song information from the external device 200 again (S115). In this case, the vehicle apparatus 100 requests the external device 200 to request the song information twice and prevents an error from occurring when the request is performed once.

When the number of requests for song information is more than 2 (Yes in S114), i.e., when the request for song information is made twice or more and the album art ID does not exist in the song information in the two requests, the vehicle apparatus 100 may determine that there is no album art in the external device 200 and may request the album art from the server 300 (S116).

Next, the vehicle device 100 starts a timer (S117) and determines whether the album art is received from the server 300 within a time of the timer (S118).

When the vehicle apparatus 100 does not receive the album art from the server 300 within the time of the timer (No in S118), the vehicle apparatus 100 displays a default album art (S119). The default album art indicates an album art image regardless of the sound source being played as an image created in advance to display as default for all sound sources without album art.

When the vehicle apparatus 100 receives the album art from the server 300 within the time of the timer (Yes S118), the vehicle apparatus 100 displays the received album art on the display device 130 (S120).

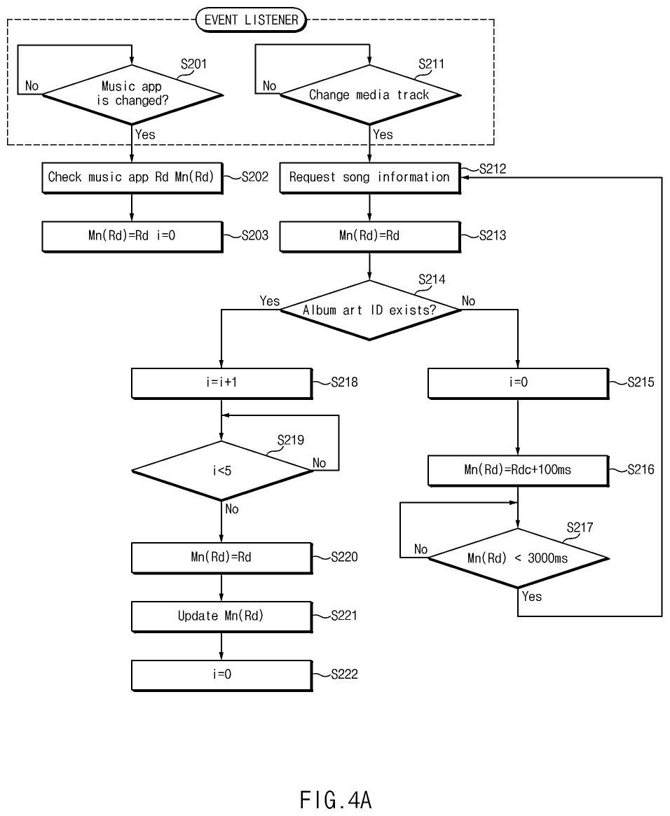

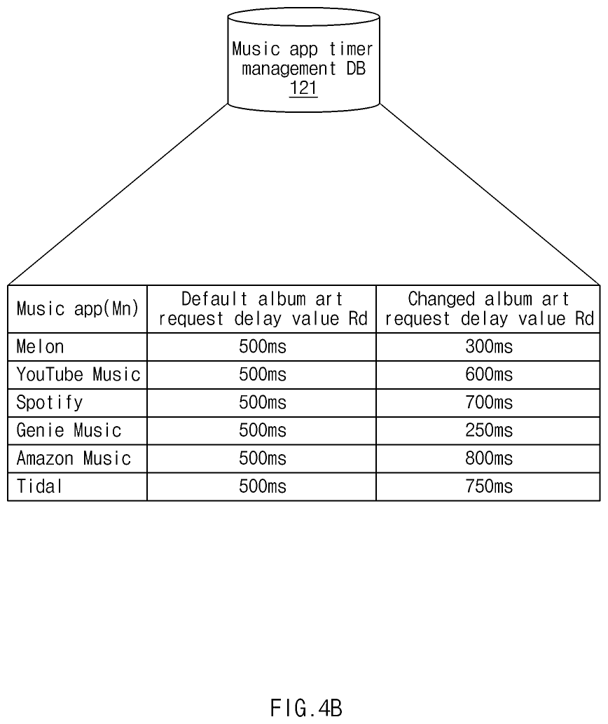

Hereinafter, a method of increasing and changing an album art request delay value according to an embodiment of the present disclosure is described in detail with reference to FIG. 4A and FIG. 4B. FIG. 4A illustrates a flowchart for describing a method of increasing and changing an album art request delay value according to an embodiment of the present disclosure. FIG. 4B illustrates an example table of changing an album art request delay value according to an embodiment of the present disclosure. In other words, when an album art preparation time is increased for each app, the vehicle apparatus 100 may increase an album art request delay value.

Hereinafter, it is assumed that the vehicle apparatus 100 of FIG. 1 performs a process of FIG. 4A. In addition, in the description of FIG. 4A, operations described as being performed by a device may be understood as being controlled by the processor 140 of the vehicle apparatus 100.

Referring to FIG. 4A, the vehicle apparatus 100 monitors whether a music app running on the external device 200 is changed or a media track is changed at a predetermined interval (S201 and S211). For example, when the user changes to YouTube Music while using the Melon app on the external device 200, the vehicle apparatus 100 may recognize that the music app has been changed. In FIG. 4A, the steps S201 and S211 may be simultaneously performed in parallel.

When the music app is changed in step S201, the vehicle device 100 may check an album art request delay value Rd of the changed music app through a music app timer management table stored in the storage 120 (S202). The vehicle apparatus 100 sets Mn(Rd)=Rd and i=0 (S203). Mn(Rd) indicates an album art request delay value Rd of the corresponding music app. i indicates a number of checks of an album art ID.

When the media track is changed in step S211, the vehicle apparatus 100 requests song information from the external device 200 (S212). The vehicle apparatus 100 sets Mn(Rd)=Rd (S213) and determines whether an album art ID exists in the song information received from the external device 200 (S214). In this case, Mn(Rd)=Rd, which is a basic value stored in the storage 120, may be 500 ms as illustrated in FIG. 4B.

When the album art ID does not exist (No in S214), the vehicle apparatus 100 sets i=0 (S215) and then sets Mn(Rd)=Rd+100 ms (S216). In this case, i indicates the number of checks of the album art ID and the number of requests for song information. The album art request delay value Rd (e.g., 500 ms) is requested and received, but there is no album art ID, so the album art request delay value is increased by 100 ms (e.g., 600 ms).

In this case, the vehicle apparatus 100 determines whether the changed album art request delay value Mn(Rd) is smaller than a maximum limit of 3000 ms (S217).

The vehicle apparatus 100 requests the song information after waiting for the changed album art request delay value Mn(Rd) smaller than the maximum limit of 3000 ms (Yes in S217) (S212).

On the other hand, when the album art ID exists in step S214 (Yes in S214), the vehicle device 100 sets i=i+1 (S218) and determines whether i is smaller than 5 (S219). When the number of requests for song information is 5 or more (No in S219), the vehicle apparatus 100 determines it as a current album art request delay value (S220) and updates the album art request delay value in the storage 120 (S221). Then, the vehicle device 100 initializes i=0 (S222).

For example, when the album art request delay value of YouTube Music is 500 ms as illustrated in FIG. 4B, when the album art ID is not received when the delay is 500 ms, the album art request delay value is increased to 600 ms. Thereafter, when the song information is requested 5 times at 600 ms and the album art ID is received all 5 times, the vehicle apparatus 100 updates the album art request delay value of YouTube Music by increasing it from 500 ms to 600 ms.

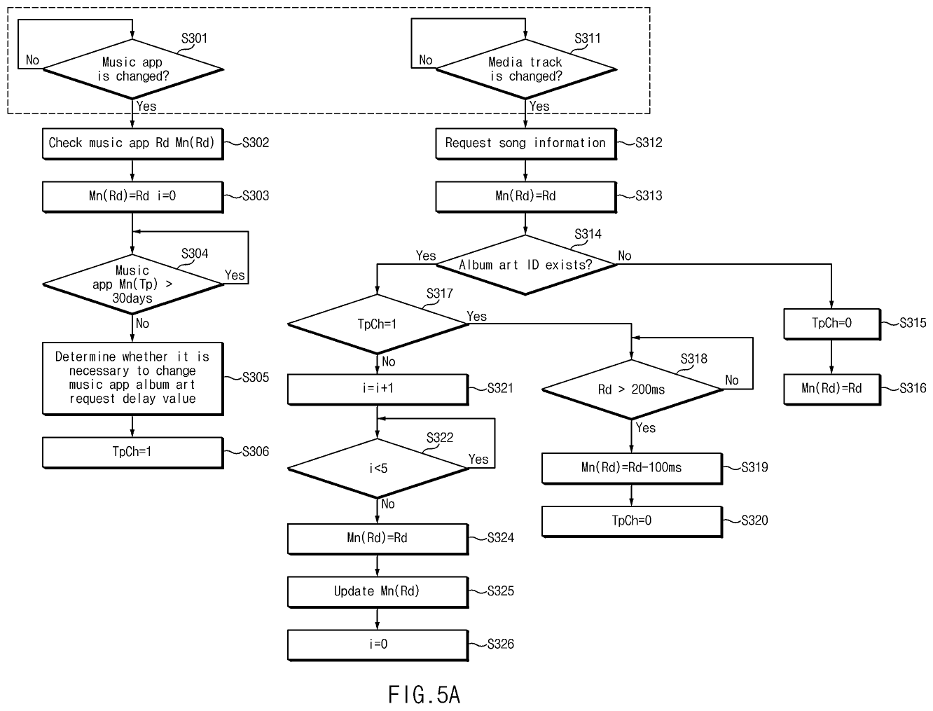

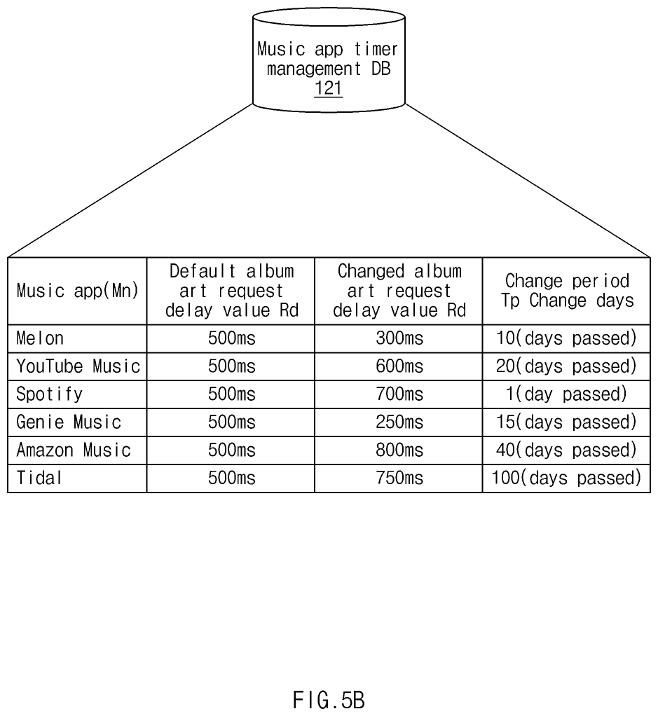

Hereinafter, a method of decreasing and changing an album art request delay value according to an embodiment of the present disclosure is described in detail with reference to FIG. 5A and FIG. 5B. FIG. 5A illustrates a flowchart for describing a method of decreasing and changing an album art request delay value according to an embodiment of the present disclosure. FIG. 5B illustrates an example of a table of a change and a change period for an album art request delay value according to an embodiment of the present disclosure. In other words, when an album art preparation time for each app is reduced, the vehicle apparatus 100 may decrease and change an album art request delay value to save a time. However, when the album art preparation time is reduced for each app, the vehicle apparatus 100 may perform a change every predetermined change period Tp. In other words, as for increasing or changing the album art request delay value, when album art is requested with an existing album art request delay value, the album art cannot be received, so the album art request delay value is immediately increased. However, when the album art preparation time is reduced, there is no problem in receiving album art even when the existing album art request delay value is used, and thus the album art request delay value is reduced and changed by monitoring every predetermined period rather than performing it every time.

Hereinafter, it is assumed that the vehicle apparatus 100 of FIG. 1 performs a process of FIG. 5A. In addition, in the description of FIG. 5A, operations described as being performed by a device may be understood as being controlled by the processor 140 of the vehicle apparatus 100.

Referring to FIG. 5A, the vehicle apparatus 100 monitors whether a music app running on the external device 200 is changed or a media track is changed at a predetermined interval (S301 and S311). The steps S301 and S311 may be simultaneously performed in parallel.

When the music app is changed in step S301, the vehicle device 100 may check an album art request delay value Rd of the changed music app through a music app timer management table stored in the storage 120 (S302). The vehicle apparatus 100 sets Mn(Rd)=Rd and i=0 (S303). Mn(Rd) indicates an album art request delay value Rd of the corresponding music app. i indicates the number of requests for song information, i.e., the number of checks of the album art ID.

The vehicle apparatus 100 determines whether the change period Tp of the music app is smaller than 30 days (S304). When the change period is smaller than 30 days (No in S304), the vehicle apparatus 100 determines that it is necessary to change the album art request delay value of the music app (S305). Next, the vehicle apparatus 100 sets a period change check flag TpCh=1 (S306).

When the media track is changed in step S311, the vehicle apparatus 100 requests song information from the external device 200 (S312). The vehicle apparatus 100 sets Mn(Rd)=Rd (S313) and determines whether an album art ID exists in the song information received from the external device 200 (S314). In this case, Mn(Rd)=Rd, which is a basic value stored in the storage 120, may be 500 ms as illustrated in FIG. 5B.

When the album art ID does not exist (No in S314), the vehicle apparatus 100 sets the period change check flag TpCh=0 (S315) and sets Mn(Rd)=Rd (S316).

Meanwhile, when the album art ID exists in step S314 (Yes S314), the vehicle apparatus 100 determines whether the period change check flag TpCh=1 (S317).

When the period change check flag TpCh=1 (Yes in S317), the vehicle apparatus 100 determines whether the album art request delay value is greater than 200 ms (S318). When the album art request delay value is greater than 200 ms (Yes in S318), the vehicle apparatus 100 sets the album art request delay value Mn(Rd)=Rd−100 ms (S319). In other words, the vehicle apparatus 100 reduces the album art request delay value by 100 ms. When the reduction change is completed, the vehicle apparatus 100 sets the period change check flag TpCh=0 (S320).

On the other hand, when TpCh is not 1 in step S317 (No in S317), the vehicle apparatus 100 increases i by 1 as i=i+1 (S321) and determines whether i is smaller than 5 (S322). When the number of requests for song information is 5 or more (No in S22), the vehicle apparatus 100 determines it as a current album art request delay value (S324) and updates the album art request delay value in the storage 120 (S325). Then, the vehicle device 100 initializes i=0 (S326).

For example, when the album art request delay value of YouTube Music is 500 ms as illustrated in FIG. 4B and when the album art ID is not received when the delay is 500 ms, the album art request delay value is increased to 600 ms. Thereafter, when the song information is requested 5 times at 600 ms and the album art ID is received all 5 times, the vehicle apparatus 100 updates the album art request delay value of YouTube Music by decreasing it from 500 ms to 400 ms.

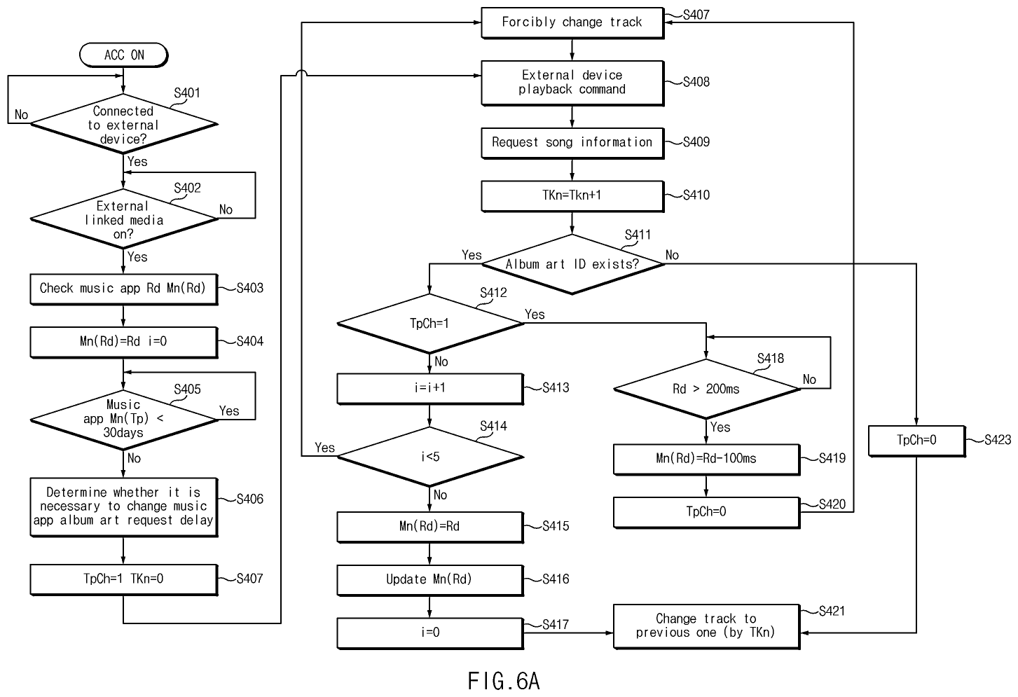

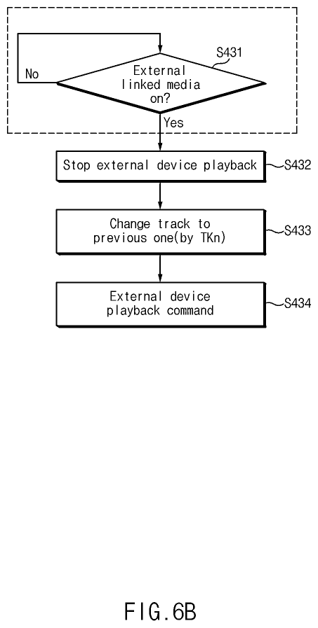

Hereinafter, a method of decreasing and changing an album art request delay value during playback of an external linked media according to an embodiment of the present disclosure is described in detail with reference to FIG. 6A and FIG. 6B. FIG. 6A and FIG. 6B each illustrate a flowchart for describing a method of decreasing or changing an album art request delay value while playing external linked media according to an embodiment of the present disclosure.

Hereinafter, it is assumed that the data sharing apparatus 100 of FIG. 1 performs the processes of FIG. 6A and FIG. 6B. In addition, in the description of FIG. 6A and FIG. 6B, operations described as being performed by a device may be understood as being controlled by the processor 140 of the vehicle apparatus 100.

Referring to FIG. 6A, the vehicle apparatus 100 determines whether it is connected to the external device 200 (S401).

The vehicle device 100 determines whether the external linked media is turned on while connected to the external device 200 (Yes in S401) (S402). The external linked media indicates a media other than music apps, such as a FM radio and an AM radio.

When the external linked media is turned on while connected to the external device 200 (Yes in S402), the vehicle apparatus 100 may verify the album art request delay value of the music app in the background even when the music app is not actually executed in the external device 200.

In other words, the vehicle device 100 may check an album art request delay value Rd of the changed music app through a music app timer management table stored in the storage 120 (S403). In this case, the music app timer management table is the same as that of FIG. 5B.

The vehicle apparatus 100 sets Mn(Rd)=Rd and i=0 (S404). Mn(Rd) indicates an album art request delay value Rd of the corresponding music app. i indicates the number of requests for song information, that is, the number of checks of the album art ID.

The vehicle apparatus 100 determines whether the change period Tp of the music app is smaller than 30 days (S405). When the change period is not smaller than 30 days (No in S405), determines that it is necessary to change the album art request delay value of the music app (S406). Next, the vehicle apparatus 100 sets a period change check requiring flag TpCh=1 and a background track changing number Tkn=0 (S407).

Then, when the music app of the external device 200 is activated (S408), the vehicle apparatus 100 requests song information from the external device 200 (S409) and sets TKn=Tkn+1 (S410).

The vehicle apparatus 100 determines whether an album art ID exists in the song information received from the external device 200 (S411).

When the album art ID does not exist (No in S411), the vehicle apparatus 100 sets a period change check flag TpCh=0 (S423) and then changes the track to a previous one (S421).

Meanwhile, when the album art ID exists in step S411 (Yes in S411), the vehicle apparatus 100 determines whether the period change check flag TpCh=1 (S412).

When the period change check flag TpCh=1 (Yes in S412), the vehicle apparatus 100 determines whether the album art request delay value is greater than 200 ms (S418). When the album art request delay value is greater than 200 ms (Yes in S418), the vehicle apparatus 100 sets the album art request delay value Mn(Rd)=Rd-100 ms (S419). In other words, the vehicle apparatus 100 reduces the album art request delay value by 100 ms. When the reduction change is completed, the vehicle apparatus 100 sets the period change check flag TpCh=0 (S420) and forcibly changes the track (S407).

On the other hand, when TpCh is not 1 in step S317 (No in S317), the vehicle apparatus 100 increases i by 1 as i=i+1 (S413) and determines whether i is smaller than 5 (S413). When the number of requests for song information is or more (No in S413), the vehicle apparatus 100 determines it as a current album art request delay value (S415) and updates the album art request delay value in the storage 120 (S416). Then, the vehicle apparatus 100 initializes i=0 (S417) and then changes the track to the previous one (S421).

Referring to FIG. 6B, the vehicle apparatus 100 determines whether the external linked media is turned on (S431) and stops playback of the external device (S432).

The vehicle apparatus 100 changes the previous track by Tkn (S433) and activates the music app of the external device 200 (S434).

As such, according to the present disclosure, it is possible to verify and change the album art request delay value of the music app in the background while a user is listening to an in-vehicle media (FM, DMB, etc.) rather than the music app of the external device 200.

According to the present disclosure, user convenience may be increased by enabling the vehicle device 100 to receive and display the album art regardless of specifications of an OS and an app of the external device 200.

In addition, usually, when a change in communication time between two apps on two devices occurs, a communication method of the two apps (request of transmission/reception of specific data and determination of data validity) must be changed at the same time. However, when the present disclosure is applied and when an app on one device is changed, apps on other devices may automatically control communication methods to automatically compensate for communication compatibility problems.

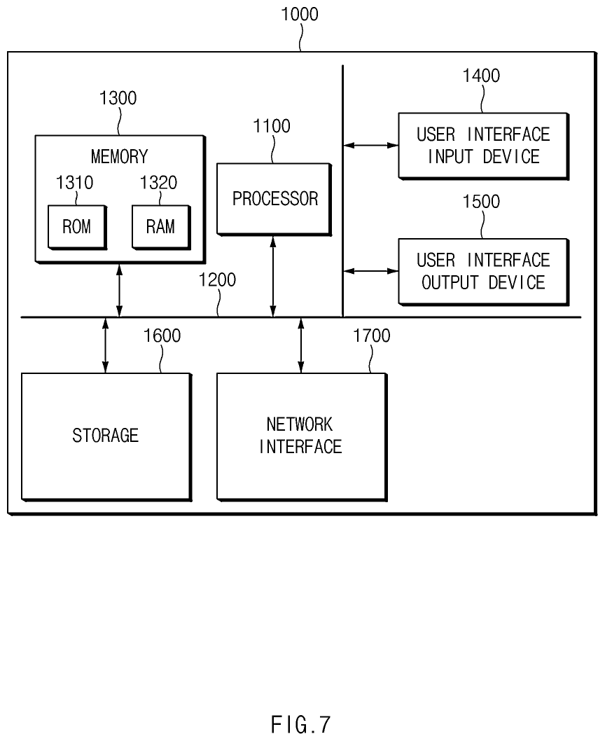

FIG. 7 illustrates a computing system according to an embodiment of the present disclosure.

Referring to FIG. 7, the computing system 1000 includes at least one processor 1100 connected through a bus 1200, a memory 1300, a user interface input device 1400, a user interface output device 1500, and a storage 1600, and a network interface 1700.

The processor 1100 may be a central processing unit (CPU) or a semiconductor device that performs processing on commands stored in the memory 1300 and/or the storage 1600. The memory 1300 and the storage 1600 may include various types of volatile or nonvolatile storage media. For example, the memory 1300 may include a read only memory (ROM) 1310 and a random access memory (RAM) 1320.

Accordingly, steps of a method or algorithm described in connection with the embodiments disclosed herein may be directly implemented by hardware, a software module, or a combination of the two, executed by the processor 1100. The software module may reside in a storage medium (i.e., the memory 1300 and/or the storage 1600) such as a RAM memory, a flash memory, a ROM memory, an EPROM memory, an EEPROM memory, a register, a hard disk, a removable disk, and a CD-ROM.

A storage medium is coupled to the processor 1100, which can read information from and write information to the storage medium. Alternatively, the storage medium may be integrated with the processor 1100. The processor and the storage medium may reside within an application specific integrated circuit (ASIC). The ASIC may reside within a user terminal. Alternatively, the processor and the storage medium may reside as separate components within the user terminal.

The above description is merely illustrative of the technical idea of the present disclosure, and those having ordinary skill in the art to which the present disclosure pertains may make various modifications and variations without departing from the essential characteristics of the present disclosure.

Therefore, the embodiments disclosed in the present disclosure are not intended to limit the technical ideas of the present disclosure, but to explain them, and the scope of the technical ideas of the present disclosure is not limited by these embodiments. The protection range of the present disclosure should be interpreted by the claims below, and all technical ideas within the equivalent range should be interpreted as being included in the scope of the present disclosure.

1. A vehicle apparatus comprising:
a communication device configured to be communication-connected with an external device;
a storage device configured to store data and at least one algorithm;
a processor coupled to the storage device and configured to execute the at least one algorithm stored in the storage device, the processor configured to
determine a type of content streaming application (app) executed by the external device when content playback is started by the content streaming app of the external device,
determine, based on the type of the content streaming app, a request time delay value for requesting content image information associated with the content played back by the content streaming app executed by the external device,
request the content image information from the external device when a time corresponding to the time request delay value has elapsed, and
in response to determining that an amount of time it takes to receive the content image information for the type of the content streaming app has changed, update the request time delay value for subsequently requesting the content image information from the external device; and
a display device configured to display the content image information that is received from the external device based on the updated request time delay value.

2. The vehicle apparatus of claim 1, wherein the amount of time it takes to receive the content image information depends on the type of the content streaming app and an operating system (OS) of the external device.

3. The vehicle apparatus of claim 1, wherein the content image information includes at least one of album art, a broadcast representative image, an advertisement image, or any combination thereof.

4. The vehicle apparatus of claim 1, wherein
the storage device is configured to store an album art request time and a change period for each content streaming app among a plurality of content streaming apps of the external device, and
the processor is configured to:
obtain, from the storage device, the album art request time for the content streaming app of executed by the external device, and
update the request time delay value by updating the album art request time, corresponding to the type of the content streaming app, stored in the storage device.

5. The vehicle apparatus of claim 1, wherein the processor is configured to, when the content playback is started by the content streaming app executed by the external device:
make a first request to the external device for content item information related to the content being played.

6. The vehicle apparatus of claim 5, wherein the content item information includes at least one of an album name, a song name, a composer name, an album art ID, or any combination thereof.

7. The vehicle apparatus of claim 5, wherein the processor is further configured to:
determine whether a content image information ID exists in the content item information when the content item information is received from the external device, and
request content image information corresponding to the content image information ID from the external device when the content image information ID exists.

8. The vehicle apparatus of claim 5, wherein the processor is configured to request the content image information from the external device after a time corresponding to the request time delay value for the content streaming app has elapsed from a time of the first request for the content item information.

9. The vehicle apparatus of claim 7, wherein the processor is further configured to make a second request for the content item information when the content image information ID does not exist in the content item information.

10. The vehicle apparatus of claim 9, wherein the processor is further configured to request the content image information from an external server when the content image information ID does not exist in the content item information received through the second request.

11. The vehicle apparatus of claim 7, wherein the processor is configured to request the content image information from an external server when the content image information ID exists in the content item information and content image information is requested from the external device based on the content image information ID and a content image is not received from the external device.

12. The vehicle apparatus of claim 11, wherein the processor is further configured to:
request the content image information from the external server, and
when the content image information is not received within a predetermined time, display default content image information on the display device.

13. The vehicle apparatus of claim 1,
wherein the processor, when the content streaming app being executed is changed or a content being played is changed, is configured to:
determine request time delay value corresponding to the changed content streaming app, and
request the content image information from the external device based on the request time delay value corresponding to the changed content streaming app, and
when the content image information is not received from the external device,
increase request time delay value corresponding to the changed content streaming app by a predetermined unit time.

14. The vehicle apparatus of claim 13, wherein the processor is further configured to:
re-request the content image information from the external device based on the increased request time delay value, and
when the content image information is received from the external device, update a request time delay value, corresponding to the changed content streaming app, stored in the storage device with the increased request time delay value.

15. The vehicle apparatus of claim 13, wherein the processor is configured to update the request time delay value, corresponding to the changed content streaming app, in the storage device when each content image information is received for a predetermined number of requests made based on the increased request time delay value.

16. The vehicle apparatus of claim 1, wherein the processor, when a content being played is changed, is configured to:
determine a request time delay value for the changed content, and
determine whether a predetermined change period has arrived, and
when the predetermined change period has arrived,
decrease the request time delay value corresponding to the changed content by a predetermined unit time.

17. The vehicle apparatus of claim 16, wherein the processor is configured to:
request content image information of the changed content from the external device based on the decreased request time delay value, and
when the content image information is received from the external device, update the decreased request time delay value, corresponding to the changed content, in the storage device when content image information is received for a predetermined number of requests based on the decreased request time delay value.

18. The vehicle apparatus of claim 16, wherein when other media is operated, the processor is configured to verify whether it is necessary to increase or decrease the request time delay value corresponding to the content streaming app of the external device in a background.

19. The vehicle apparatus of claim 18, wherein the processor is further configured to, when the content streaming app of the external device is executed while the processor is verifying whether it is necessary to increase or decrease the request time delay value, return a track moved for verifying whether it is necessary to increase or decrease the request time delay value, to a track that was played before verification to play the track.

20. A method of displaying content image information received from an external device, the method comprising:
performing, by a processor, communication connection for providing content with an external device;
determining, by the processor, a type of a content streaming app of the external device;
determining, by the processor, a request time delay value for requesting content image information for the type of the content streaming app when content playback is started by the content streaming app of the external device;
requesting, by the processor, the content image information from the external device when a time corresponding to the time request delay value has elapsed;
in response to determining that an amount of time it takes to receive the content image information for the content streaming app has changed updating, by the processor, the request time delay value for the type of the content streaming app; and
displaying, by the processor, the content image information that is received based on the updated request time delay value.
